(19) United States
(12) Patent Application Publication
(10) Pub. No.: US 2017/0133792 A1
(43) Pub. Date: May 11, 2017

(54) CONNECTOR ILLUMINATION FOR INSERTION IN LOW-LIGHT CONDITIONS

(71) Applicant: APPLE INC., Cupertino, CA (US)

(72) Inventors: Charles W. Werley, Cupertino, CA (US); George V. Anastas, San Carlos, CA (US); Jeffrey J. Terlizzi, San Francisco, CA (US); Robert D. Zupke, Cupertino, CA (US); Scott Krueger, San Francisco, CA (US); Todd K. Moyer, Saratoga, CA (US); Zachary C. Rich, Sunnyvale, CA (US); Jahan C. Minoo, San Jose, CA (US)

(73) Assignee: APPLE INC., Cupertino, CA (US)

(21) Appl. No.: 15/254,574

(22) Filed: Sep. 1, 2016

Related U.S. Application Data
(60) Provisional application No. 62/235,067, filed on Sep. 30, 2015.

(51) Int. Cl. H01R 13/641; H01R 29/00

(52) U.S. Cl. CPC H01R 13/641; H01R 29/00

(57) ABSTRACT

Connector systems that may facilitate the insertion of connector inserts into connector receptacles, may eliminate the need for dedicated contacts to detect a connection, and may provide connector inserts that are rotatable even when the functions of the contacts on the connector inserts are not symmetrical.

### CROSS REFERENCE TO RELATED APPLICATIONS

The present application claims the benefit of U.S. provisional application No. 62/235,067, filed Sep. 30, 2015, which is hereby incorporated by reference.

### BACKGROUND

The number and types of electronic devices available to consumers have increased tremendously the past few years and this increase shows no signs of abating. Electronic devices, such as portable media players, storage devices, tablets, netbooks, laptops, desktops, all-in-one computers, wearable computing devices, smart phones, televisions, monitors and other display devices, navigation systems, and other devices have become ubiquitous in recent years.

These devices often share power and data using various cables. These cables may have connector inserts, or plugs, on one or both ends. The connector inserts may plug into connector receptacles on electronic devices, thereby forming one or more conductive paths between devices for signals and power.

But it may be difficult for some users in some circumstances to plug a connection insert into a connector receptacle. For example, it may be dark and a user may have to make the connection by feel. Other users may be blind or have difficulty seeing well. Again, such as user may have to plug the connector insert into the connector receptacle on a device strictly by feel.

Also, once a connection is made, the newly connected devices may detect the presence of each other and begin to transfer data and power. But such detection may require a dedicated contact in the connector insert and the connector receptacle. If this contact is not required, either the connector insert and connector receptacle could be made smaller or an additional contact for either data or power transfer would be available.

Also, a connector insert may not be rotatable. That is, a connector insert may be rotationally symmetrical, but the functions of the contacts on the connector insert may not be symmetrical. This may mean that the connector insert may need to be plugged in to a connector receptacle in a specific orientation. But it may be easier to plug a fully rotatable connector inserts into a connector receptacle.

Thus, what is needed are connector systems that may facilitate the insertion of connector inserts into connector receptacles, may eliminate the need for dedicated contacts to detect a connection, and may provide connector inserts that are rotatable even when the functions of the contacts on the connector inserts are not symmetrical.

### SUMMARY

Accordingly, embodiments of the present invention may provide connector systems that may facilitate the insertion of connector inserts into connector receptacles, may eliminate the need for dedicated contacts to detect a connection, and may provide connector inserts that are rotatable even when the functions of the contacts on the connector inserts are not symmetrical.

An illustrative embodiment of the present invention may provide a connector insert that may facilitate its insertion into a connector receptacle by having a light-emitting diode (LED). The LED may provide illumination in a dark environment, thereby making it easier for a user to plug the connector insert into a corresponding connector receptacle. The illumination may also make it easier to for a user to find the connector insert. The LED may be on a front, top, back, or sides, or combination thereof, on a housing of the connector insert. The LED may be activated by an accelerometer or motion sensor. When the connector insert is mated with the corresponding connector receptacle, the connector insert may detect the connection and turn the LED off. In these and other embodiments of the present invention, an LED may be may be on or near the connector receptacle instead of the connector insert, or LEDs may be on both the connector insert and the connector receptacle. In each of these examples and other embodiments of the present invention, the connector insert may be part of a second electronic device, where the connector insert of the second electronic device connects directly to an electronic device housing the connector receptacle without the use of an intervening cable.

In these and other embodiments of the present invention, the intent of a user to plug a connector insert into a connector receptacle may be determined and an output may be provided in response. For example, an intent of a user to plug a connector insert into a connector receptacle may be determined by detecting motion. In these and other embodiments of the present invention, instead of detecting motion, other types of events may be detected and used to turn on or activate an output device. For example, a pressure or touch sensor may detect that a user has picked up the connector insert and may infer that the user is going to plug it in to a device. Similarly, a user's touch may change a temperature or capacitance seen at a connector insert, and the intent of the user may be inferred. In these and other embodiments of the present invention, a voice-activated command may be an event that turns on the output device.

In these and other embodiments of the present invention, various output devices may be activated in response to a determination that a user intends to make a connection. For example, an LED or other illumination source may be provided as an output. Instead of an LED providing light as an output, other types of outputs may be provided by other types of output devices. For example, a haptic engine may cause the connector insert to vibrate when movement of the connector insert or other event is detected. This vibration may become more intense or change in other ways as the connector insert is brought closer to the connector receptacle. In these and other embodiments, a sound may be produced when movement of the connector insert or other event is detected. This sound may become louder or change in pitch or in other ways as the connector insert is brought closer to the connector receptacle. In various embodiments of the present invention, one or more of the above events may be used to generate one or more of these outputs.

In these and other embodiments of the present invention, when the connector insert is inserted into a connector receptacle, the output, such as light emitted by an LED, may cease. This connection may be detected by sensing a voltage or current on a contact of the connector receptacle, connector insert, or both. In various embodiments of the present invention, a contact on a connector receptacle may be used to detect a connection to a connector insert. In these and other embodiments of the present invention, circuitry in the connector insert itself, or circuitry in a remote device having a connector receptacle coupled to the connector insert via a cable, may be used to detect a connection to a connector insert.

In these and other embodiments of the present invention, before a connection is made, a source impedance of a power supply provided by the connector insert may be high. This may protect users from voltages on contacts in a connector insert that is not plugged into a device. Once a connection is detected, the source impedance of the power supply voltage provided by the connector insert may drop, thereby allowing the connected device to draw power from the power supply provided by the connector insert. This source impedance may be located in the connector insert or in a remote device having a connector receptacle coupled to the connector insert via a cable. Instead of reducing a source impedance, such a detection may be used to turn on a power supply voltage that may be provided by the connector insert. In these and other embodiments of the present invention, other events may be triggered by the formation of a connection.

In these and other embodiments of the present invention, instead of detecting an actual connection, either or both a connector insert and a connector receptacle may include a proximity sensor that may determine that the connector insert is close to the connector receptacle. This detected proximity may be used to turn off an output device, such as the above LED. It may also be used to reduce a source impedance of a power supply voltage, or turn on a power supply voltage, that may be provided by the connector insert or connector receptacle.

In various embodiments of the present invention, the proximity may be detected using a reed switch. When a connector insert having a reed switch is brought into the proximity of a connector receptacle having a magnetic field, the reed switch may change state, from open to closed, or from closed to open, depending on the type of reed switch used. This change may be detected and used to turn off an output device, such as the above LED. It may also be used to reduce a source impedance of a power supply voltage, or turn on a power supply voltage, that may be provided by the connector insert or connector receptacle.

In these and other embodiments of the present invention, a Hall-effect sensor may be used in place of a reed switch to determine polarity. A Hall-effect sensor may also provide polarity information. This may be used to make connector inserts that are only physically rotatable into fully rotatable connector inserts, even though the functions provided by the contacts of the connector inserts are not symmetrical. For example, a connector insert may have only a power contact and a ground contact, that is, its contacts may not be symmetrical. The connector insert may be physically capable of being plugged into a connector receptacle in either of two orientations separated by 180 degrees. Since the polarity of the connector insert may be determined with a Hall-effect sensor, the power contact and ground contact of the connector insert may be reversed when the connector insert is inserted in a rotated position and not reversed when the connector insert is inserted in a normal position. This capability may make the connector insert fully rotatable, even though the functions provided by the contacts of the connector inserts are not symmetrical.

In various embodiments of the present invention, the components of the connectors may be formed in various ways of various materials. For example, contacts or pins, interconnect lines, and other conductive portions of the connectors may be formed by stamping, metal-injection molding, machining, printing, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the housings, and other portions, may be formed using injection or other molding, 3-D printing, machining, or other manufacturing process. The nonconductive portions may be formed of silicon or silicone, rubber, hard rubber, plastic, nylon, elastomers, liquid-crystal polymers (LCPs), ceramics, or other nonconductive material or combination of materials.

Embodiments of the present invention may provide connector inserts that may connect to connector receptacles on various types of devices, such as portable computing devices, tablet computers, desktop computers, laptops, all-in-one computers, wearable computing devices, cell phones, smart phones, media phones, storage devices, portable media players, navigation systems, monitors, power supplies, adapters, remote control devices, chargers, and other devices. These connector inserts and connector receptacles may be compliant with various standards such as Universal Serial Bus (USB), USB2, USB3, USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these connector inserts and connector receptacles may be used to convey power, ground, signals, test points, and other voltage, current, data, or other information. In a specific embodiment of the present invention, the connectors may include three contacts, a bidirectional power contact, a bidirectional data contact, and ground.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an electronic system according to an embodiment of the present invention;

FIG. 2 is a schematic of a connector insert according to an embodiment of the present invention;

FIG. 3 is a flowchart of a method of facilitating a connection according to an embodiment of the present invention;

FIG. 4 is a flowchart of a method of facilitating a connection according to an embodiment of the present invention;

FIG. 5 is a flowchart of a method of facilitating a connection according to an embodiment of the present invention;

FIG. 6 illustrates an electronic system according to an embodiment of the present invention;

FIG. 7 is a schematic of a connector system according to an embodiment of the present invention;

FIG. 8 illustrates an electronic system according to an embodiment of the present invention;

FIG. 9 is a schematic of a connector system according to an embodiment of the present invention; and

FIG. 10 is a flowchart of a method of operation of a connector insert according to an embodiment of the present invention.

### DESCRIPTION OF ILLUSTRATIVE EMBODIMENTS

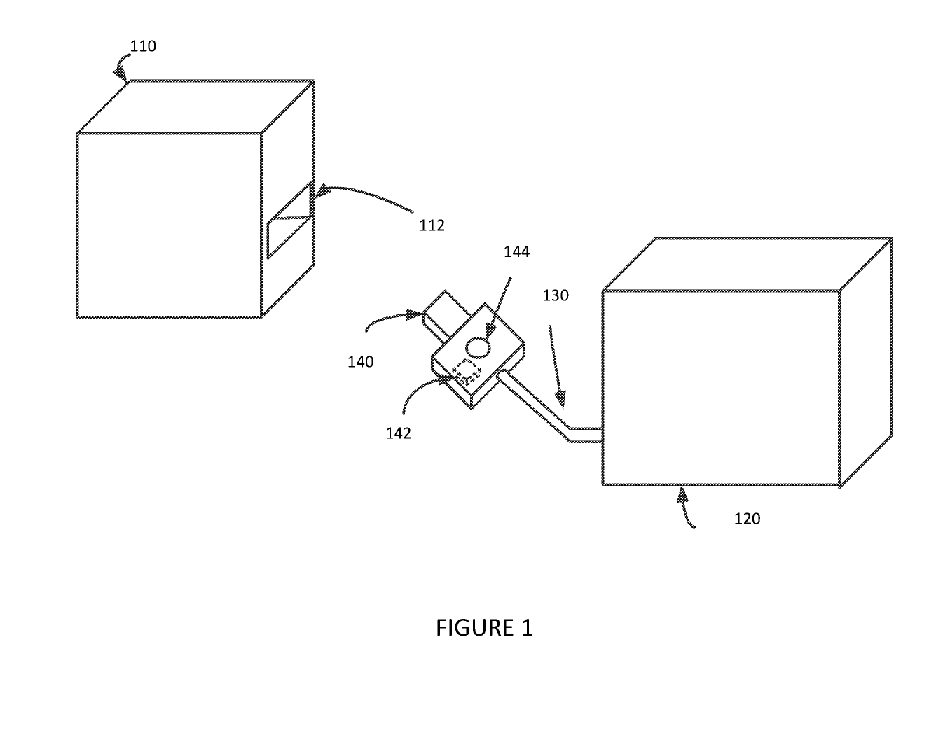

FIG. 1 illustrates an electronic system according to an embodiment of the present invention. This figure, as with the other included figures, is shown for illustrative purposes and does not limit either the possible embodiments of the present invention or the claims.

This figure includes an electronic device 110 having a connector receptacle 112. A second electronic device 120 may be attached to cable 130. Cable 130 may be a tethered cable that is attached directly to electronic device 120, or cable 130 may include a connector insert plugged into a connector receptacle (not shown) of electronic device 120. Cable 130 may terminate in connector insert 140. Connector insert 140 may be compatible with connector receptacle 112. Accordingly, electronic device 110 may communicate and transfer power with electronic device 120 after connector insert 140 is plugged into connector receptacle 112. In each of these examples and other embodiments of the present invention, connector insert 140 may be part of electronic device 120, where connector insert 140 and electronic device 120 connect directly to connector receptacle 112 of electronic device 110 without the need for the intervening cable 130. For example, connector insert 140 and connector receptacle 112 may have surface contacts on surfaces of electronic devices 120 and 110. These surfaces may make a direct connection, as opposed to where a connector insert is plugged into a connector receptacle.

Again, it may be difficult in some circumstances for some users to plug connector insert 140 into connector receptacle 112. For example, a user may attempt to plug connector insert 140 into connector receptacle 112 in a dark room. Also, a user may be blind or have trouble seeing. Accordingly, embodiments of the present invention may provide connector inserts 140 that may facilitate the formation of this connection. In each of examples shown here, embodiments the present invention may be incorporated in a connector receptacle, such as connector receptacle 112, in a connector insert, such as connector insert 140, or in both a connector insert and a connector receptacle.

In various embodiments of the present invention, an intent of a user to plug connector insert 140 into connector receptacle 112 may be detected. This intent may be divined from the occurrence of an event. This event may cause an output to be generated. The output may be useful in guiding the user towards a successful insertion of connector insert 140 into connector receptacle 112. After connector insert 140 is inserted into connector receptacle 112, the generated output may cease.

In each of the included examples and other embodiments of the present invention, connector insert 140 may include an accelerometer or motion detector 142 and an LED. Accelerometer 142 may activate the LED (not shown) such that light is emitted through opening or light passage 144. Light emitted from opening 144 may provide helpful or sufficient illumination for connector insert 142 be plugged into connector receptacle 112. Opening 144 may be located on a front, sides, top, bottom, or other portion or combination thereof on a housing of connector insert 142. This may facilitate the plugging of connector insert 140 into connector receptacle 112 in a dark environment.

In each of the included examples and other embodiments of the present invention, a user's intent to plug connector insert 140 into connector receptacle 112 may be determined in other ways besides detecting motion using an accelerometer or motion detector 142. For example, a sensor may be located on a surface of a housing of connector insert 140. This sensor may be sensitive to touch, temperature, pressure, capacitance, or other parameter that may be used to determine that a user has grasped connector insert 140. Also, in each of the included examples and other embodiments of the present invention, other types of output devices and outputs besides LEDs and light may be used to facilitate the insertion of connector insert 140 into connector receptacle 112. For example, a speaker providing and audio feedback may be provided. This feedback may change in amplitude or pitch depending on the proximity of the connector insert 140 to connector receptacle 112. In other embodiments of the present invention, a haptic engine may be present in connector receptacle 140. This haptic engine may vibrate or provide other types of feedback to a user guiding the user to a successful insertion of connector insert 140 into connector receptacle 112. In each of these examples and other embodiments of the present invention, once a successful insertion of connector insert 140 into connector receptacle 112 achieved, connector insert 140 may detect this connection and cease the generation of the output.

In these and other embodiments of the present invention, electronic device 110 and electronic device 120 may be various types of electronic devices. For example, they may be portable computing devices, tablet computers, desktop computers, laptops, all-in-one computers, wearable computing devices, cell phones, smart phones, media phones, storage devices, portable media players, navigation systems, monitors, power supplies, adapters, remote control devices, chargers, and other devices. Connector insert 140 and connector receptacle 112 may convey various types of signals for various types of interfaces including standards such as Universal Serial Bus (USB), USB2, USB3, USB Type-C, High-Definition Multimedia Interface (HDMI), Digital Visual Interface (DVI), Ethernet, DisplayPort, Thunderbolt, Lightning, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these connector inserts and connector receptacles may be used to convey power, ground, signals, test points, and other voltage, current, data, or other information. In a specific embodiment of the present invention, the connectors may include three contacts, a bidirectional power contact, a bidirectional data contact, and ground.

In these and other embodiments of the present invention, connector receptacles and connector inserts may avoid providing voltages, or they may provide voltages having a high source impedance, on their contacts until a connection has been formed. This may prevent users from encountering voltages on exposed contacts of these connectors. Once a connection has been made, voltages may either be provided, the source impedance may be reduced, or both. For clarity, this action will typically be referred to below as a reduction in source impedance. At the time the connection has been detected, the output signal, either light, sound, vibration, or other output signal, may also be stopped. An example of such a connector insert is shown in the following figure.

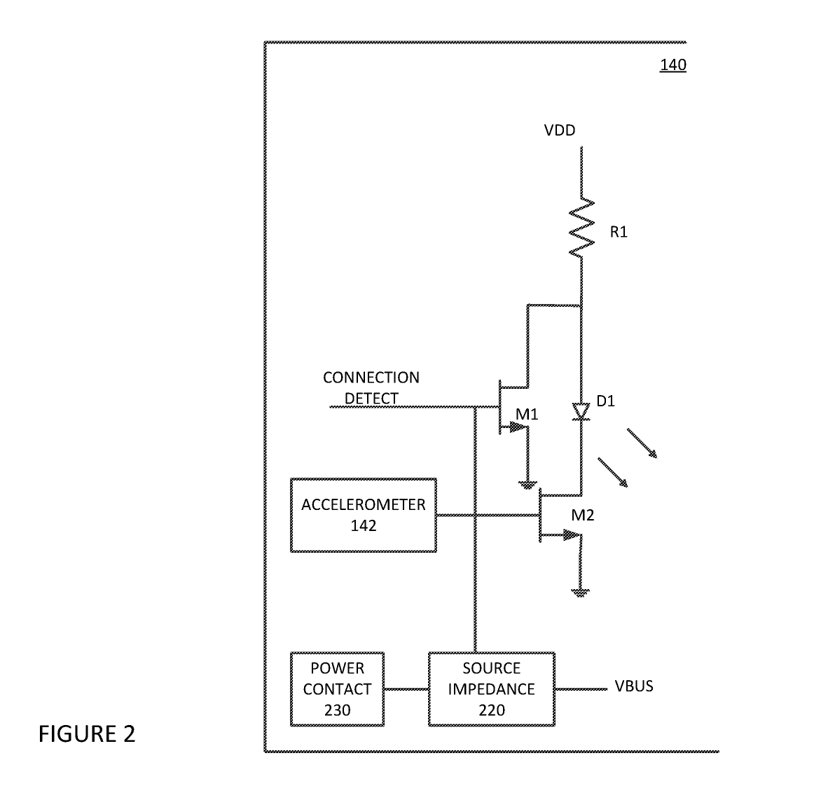

FIG. 2 is a schematic of a connector insert according to an embodiment of the present invention. Connector insert 140 may include accelerometer 142. When a user moves connector insert 140, accelerometer 142 may become active, thereby turning transistor M2 on. Current may flow through LED D1, causing LED D1 to emit light. After connector insert 140 is successfully mated with a connector receptacle, the connection detect signal may go high, thereby turning transistor M1 on. Transistor M1 may direct current away from LED D1, thereby turning off LED D1. The connection detect signal may also be used to decrease a source impedance in circuit 220 for the VBUS power supply. The source impedance 220 may be in series with power contact 230. In various embodiments of the present invention, the source impedance circuitry 220 may be located in connector insert 140, or it may be located in a remote device having a connector receptacle attached to connector insert 140 via a cable.

A flowchart illustrating the operation of the circuit of FIG. 2 is shown in the following figure.

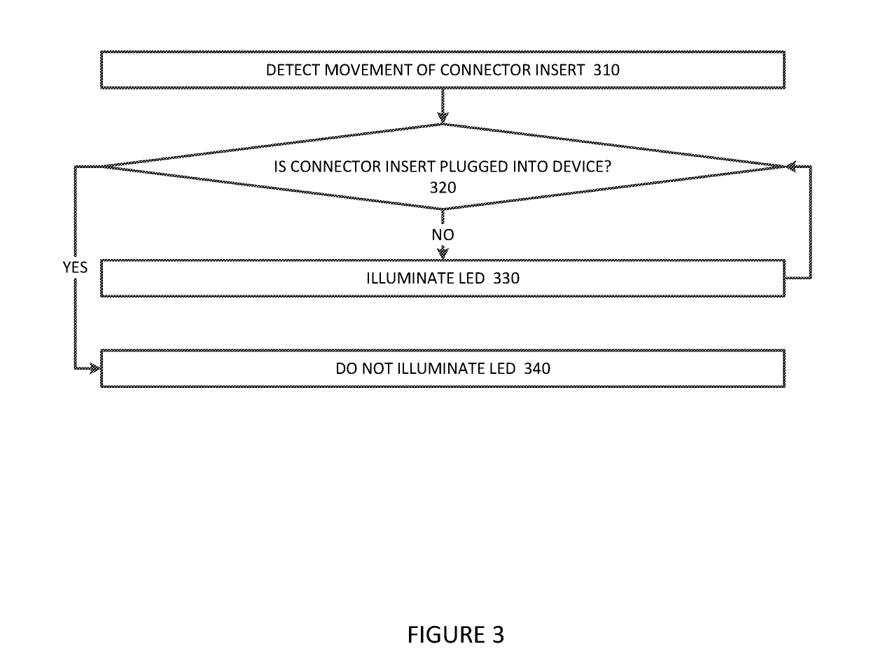

FIG. 3 is a flowchart of a method of facilitating a connection according to an embodiment of the present invention. In act 310, a movement of a connector insert may be detected. In act 320, it may be determined whether the connector insert is plugged into a corresponding receptacle on an electronic device. It the connector insert is not plugged into a connector receptacle, an LED may be illuminated in act 330. If the connector insert is already plugged in, there is no need for light and the LED is not illuminated in act 340. After the LED is illuminated in act 330, once the connector insert is plugged into a corresponding connector receptacle in an electronic device in act 320, the LED may be turned off in act 340.

In these examples and other embodiments of the present invention, the output device may be an LED, speaker, haptic engine, or other output device. The output device may be on a timer such that if no connection to a connector receptacle is detected after a first a duration, the output device may be turned off. In various embodiment of the present invention, to prevent the output device from turning back on too rapidly, a timeout period may be enforced. This timeout period may be successively lengthened to prevent the LED from being repeatedly turned on and off.

Again, in various embodiments of the present invention, when a connection has been detected, a voltage may be provided on power contacts of a connector insert or connector receptacle, or a source impedance of voltages on the power contacts may be reduced. In these and other embodiments of the present invention, other events may be triggered by the formation of a connection. An example is shown in the following figure.

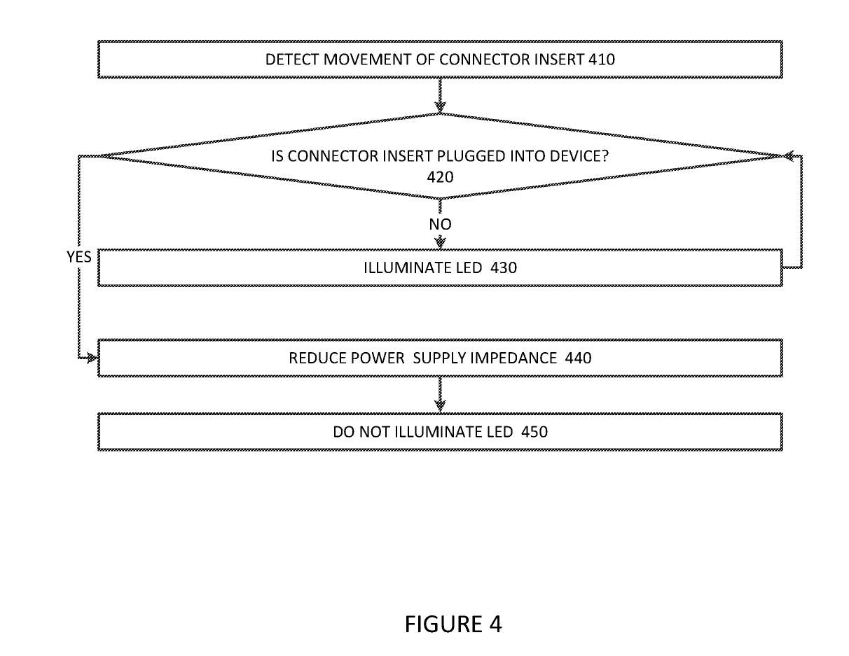

FIG. 4 is a flowchart of a method of facilitating a connection according to an embodiment of the present invention. In act 410, a movement of a connector insert may be detected. In act 420, it may be determined whether the connector insert is plugged into a connector receptacle in an electronic device. If the connector insert is not plugged into a connector receptacle, an LED may be illuminated in act 430. If the connector insert is already plugged into a connector receptacle, a power supply may have its impedance reduced in act 440, and the LED may not be illuminated in act 450. If the LED is illuminated in act 430, once the connector insert is plugged into a receptacle in act 420, a power supply impedance may be reduced in act 440 and the LED be may be turned off in act 450.

In various embodiments of the present invention, instead of detecting a connection, an embodiment of the present invention may detect a proximity to a second connector. It may use this proximity information in turning off an output device, such as an LED or other output device. Also, it may trigger a reduction in a power supply impedance or may cause a power supply to be available at a connector contact. An example is shown in the following figure.

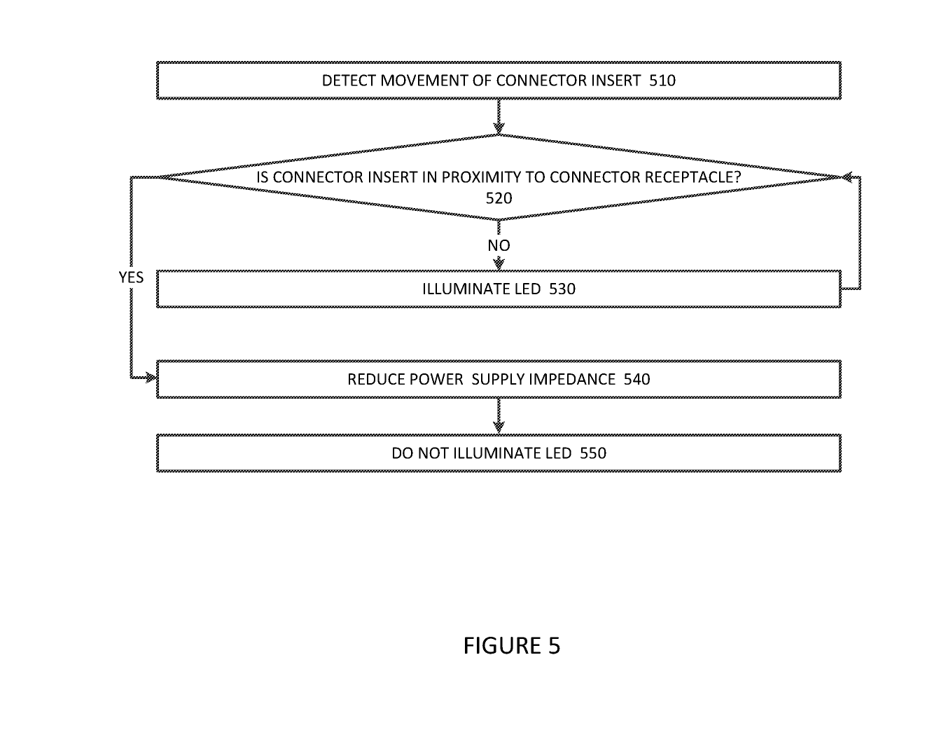

FIG. 5 is a flowchart of a method of facilitating a connection according to an embodiment of the present invention. In act 510, a movement of a connector insert may be detected. In act 520, it may be determined whether a connector insert is in proximity to a connector receptacle. If the connector insert is not in proximity to a connector receptacle, an LED may be illuminated in act 530. If the connector insert is in proximity to a connector receptacle, the power supply impedance may be reduced in act 540, and the LED is not illuminated in act 550. If the LED is illuminated in act 530, once it is detected that a connector insert is in proximity to the connector receptacle, a power supply impedance may be reduced or a power supply voltage may be provided in act 540 and the LED may be turned off in act 550.

In these and other embodiments of the present invention, the output device, whether it be an LED, speaker, haptic engine, or other output device, may be on a timer such that if proximity to a corresponding connector is not detected after a first a direction, the output device may be turned off. In various embodiment of the present invention, to prevent the output device from turning back on too rapidly, a timeout period may be enforced. This timeout period may be successively lengthened to prevent the LED from being repeatedly turned on and off.

In various embodiments of the present invention, the proximity between connector insert 140 and connector receptacle 112 may be detected in various ways. In various embodiments of the present invention, connector receptacle 112 may contain one or more magnets. The magnetic field lines generated by these one or more magnets may be detected by a sensor in connector insert 140. This sensor may be used to determine that connector insert 140 is proximate to connector receptacle 112. These sensors may be reed switches, Hall-effect sensors, or other types of sensors. This information may be used to turn off an output device, such as an LED. It may also be used to reduce a source impedance of a voltage, or to provide a voltage, at a contact of connector insert 140. An example is shown in the following figure.

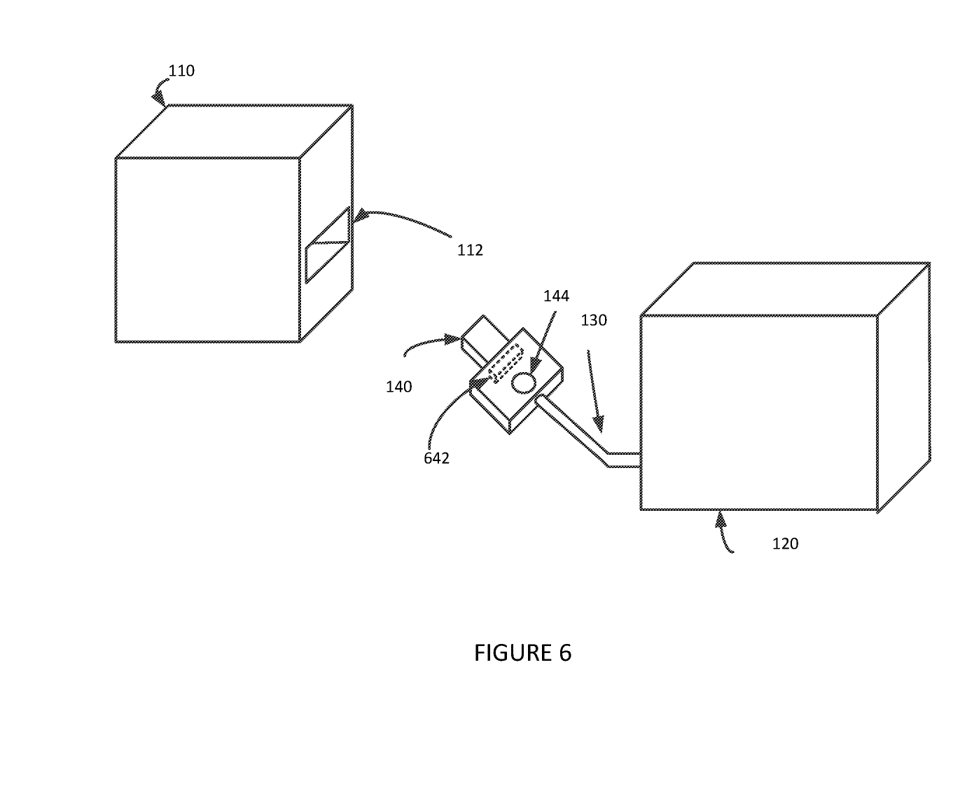

FIG. 6 illustrates an electronic system according to an embodiment of the present invention. As before, electronic device 110 may include receptacle 112. Receptacle 112 may include one or more magnets (not shown.) Electronic device 120 may be attached to cable 130, which may terminate in connector insert 140. Connector insert 140 may include reed switch 642. Reed switch 642 may be coupled to an LED (not shown.) This LED may provide light using one or more openings 144 on connector insert 140 as described above.

When motion is detected by connector insert 140, an LED may provide illumination such that a user may plug connector insert 140 into connector receptacle 112 in a dark environment. Once connector insert 140 is proximate to connector receptacle 112, the magnetic field generated by the one or more magnets in connector receptacle 112 may cause reed switch 642 to change state. This may turn off the LED or other utilized output device. The change in state of reed switch 642 may also cause a source impedance of a power supply voltage provided on one of the contacts in connector insert 140 to be reduced, or it may cause an output voltage to be provided. An example of such a connector insert is shown in the following figure.

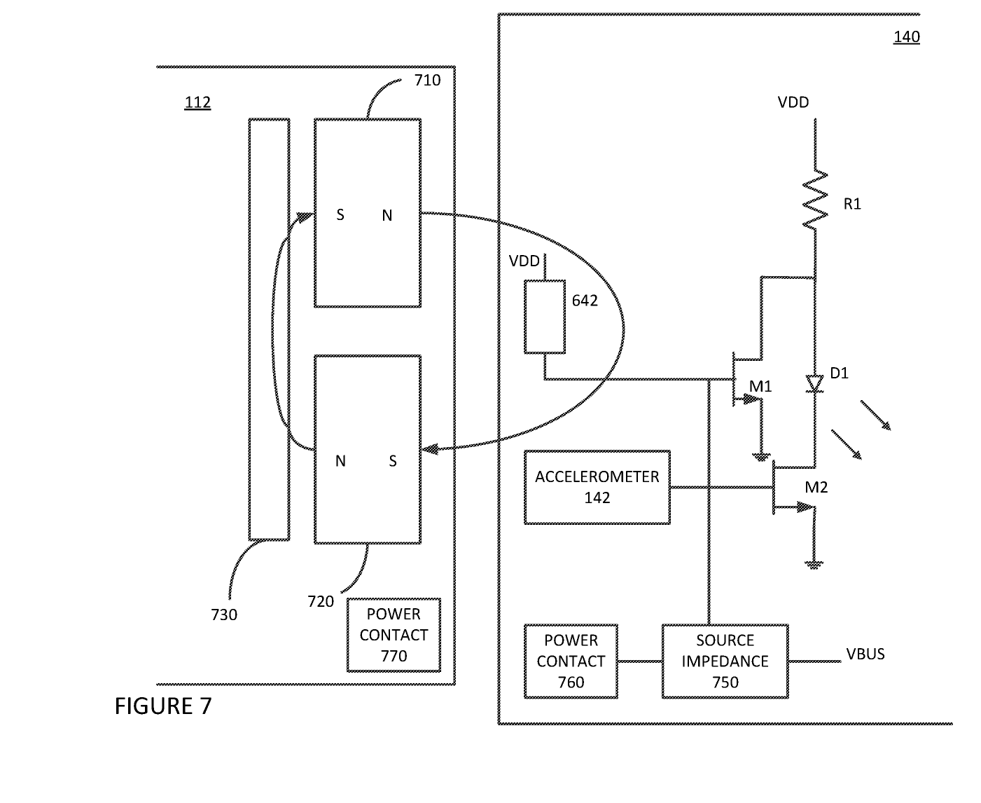

FIG. 7 is a schematic of a connector system according to an embodiment of the present invention. In this example, connector receptacle 112 may include magnets, shown here as magnets 710 and 720. These magnets may have opposing polarities such that magnetic lines originating in magnets 710 may terminate in magnets 720, as shown. Receptacle 710 may include a back plate 730 for guiding magnetic field lines from magnet 720 back to magnet 710. Connector receptacle 112 may further include one or more contacts 770 for receiving power supply voltages.

Connector insert 140 may include an accelerometer 142, as before. When connector insert 140 is moved, accelerometer 142 may become active, thereby turning on transistor M2. LED D1 may illuminate, thereby facilitating a user's attempt to plug connector insert 140 into connector receptacle 112. Connector insert 140 may also include reed switch 642. When reed switch 642 does not detect a magnetic field, transistor M1 may be off. When reed switch 642 detects a magnetic field, reed switch 642 may close and connect the gate of transistor M1 to VDD or other power supply. This may turn transistor M1 on, which may direct current away from LED D1, thereby shutting off LED D1. In other embodiments of the present invention, other types of reed switches having a different mode of operation may be utilized. Also, when a magnetic field is detected and reed switch 642 connects the gate of transistor M1 to VDD, a signal may be provided to source impedance circuit 750. This may lower a source impedance of the voltage VBUS, which may be provided on power contact 760 to connector receptacle 112 via power contact 770. The source impedance 750 may be located in connector insert 140 or in a remote device having a connector receptacle coupled to connector insert 140 via a cable.

In other embodiments of the present invention, other types of proximity sensors may be used. In various embodiments the present invention, a Hall-effect sensor may be used. An example is shown in the following figure.

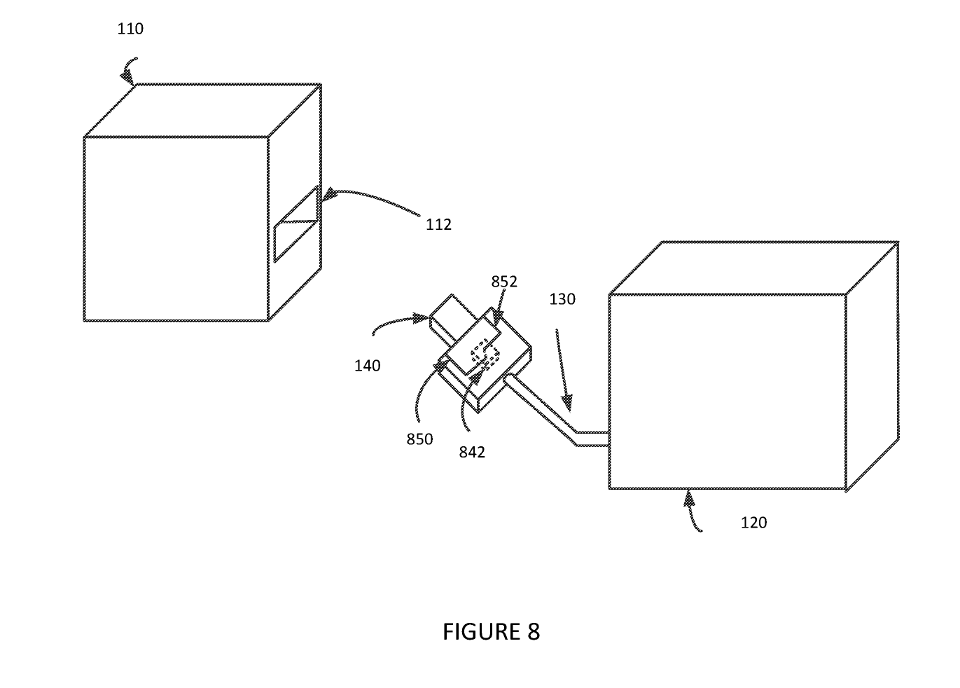

FIG. 8 illustrates an electronic system according to an embodiment of the present invention. In this example, connector receptacle 140 may include a Hall-effect sensor 842. The Hall-effect sensor 842 may detect the magnet field generated by the one or more magnets in connector receptacle 112 in order to determine that connector insert 140 is proximate to connector receptacle 112.

In various embodiments of the present invention, the inclusion of Hall-effect sensor 842 may cause space issues in connector insert 140. Specifically, the Hall-effect sensor 842 should be placed at a right angle to a magnetic field to be detected. As shown in the example above, magnetic field lines associated with connector receptacle 112 may flow across a front of connector receptacle 112. This could mean that that Hall-effect sensor 842 may need to be on its side in connector receptacle 140. Since connector inserts, such as connector insert 140, typically have a fairly flat form factor, it may be useful to place Hall-effect sensor 842 in that orientation. Accordingly, one or more pole pieces 850 and 852, which may be made of a ferromagnetic material, may be used to redirect the direction of field lines from magnets in connector receptacle 112. An example is shown in the following figure.

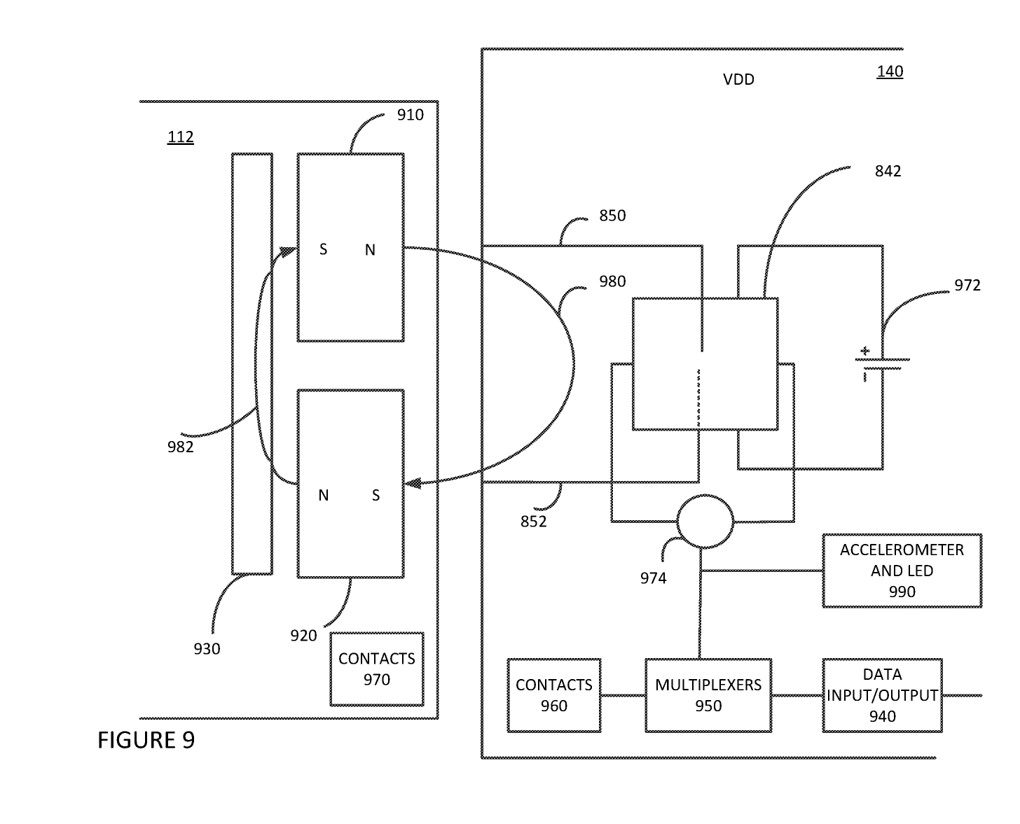

FIG. 9 is a schematic of a connector system according to an embodiment of the present invention. As before, connector receptacle 112 may include magnets 910 and 920. Magnetic field lines 980 originating in magnet 910 may terminate in magnet 920, as shown. Connector receptacle 112 may further include a back plate 930 and contacts 970 as before. Magnetic field lines 982 originating in magnet 920 may terminate in magnet 910, as shown

Connector insert 140 may include an accelerometer and LED 990. When connector insert 140 is moved, accelerometer may turn on an LED or other output device. Connector insert 140 may also include Hall-effect sensor 842. A bias voltage 972 may be applied to first and second opposing sides of Hall-effect sensor 842. A resulting voltage may be read from intermediate and opposing sides of Hall-effect sensor 842. This voltage may be read and amplified by amplifier 974. As can be seen, in this example magnetic field lines 980 between magnet 910 and magnet 920 in connector receptacle 112 move laterally across a face of connector receptacle 112. To change this direction into a direction that is orthogonal to Hall-effect sensor 842, one or more pole pieces 850 and 852 may be used. These pole pieces 850 and 852 may translate the lateral magnetic field lines 980 to magnetic field lines (not shown) extending above and below Hall-effect sensor 842. These pole pieces 850 and 852 may have terminating ends pointing towards a top and bottom of Hall-effect sensor 842. In this way, the magnetic field to be measured may be moved to be orthogonal to Hall-effect sensor 842.

Unlike the reed switch an example above, Hall-effect sensor 842 may be used to measure a magnitude of a magnetic field and its direction. The magnitude information may be used to vary a strength of an output. For example, LED 990 may become brighter as the proximity increases. The direction information may be used to determine whether a connector insert 140 is being inserted in a normal or an inverted position. This may be of particular use where connector insert 140 may be physically inserted into connector receptacle 112 in either of two orientations separated by 180 degrees, but where the functions of the contacts 960 are not symmetrical. Multiplexers 950 may be employed to reverse an order of functions on the contacts 960 in the connector insert 140 as needed, thereby making the connector insert fully rotatable. Accordingly, multiplexers 950 may be connected between input and output circuits 940 and contacts 960. Multiplexers 950 and input and output circuits 940 may be located in either connector insert 140 or an electronic device, such as electronic device 120 having a connector receptacle, such as connector receptacle 112, coupled to connector insert 140 via a cable. As before, a source impedance of a power supply voltage may be reduced once it is determined that connector insert 140 is proximate to connector receptacle 112. This circuitry is not shown for simplicity. The operation of this connector system is shown in the following figure.

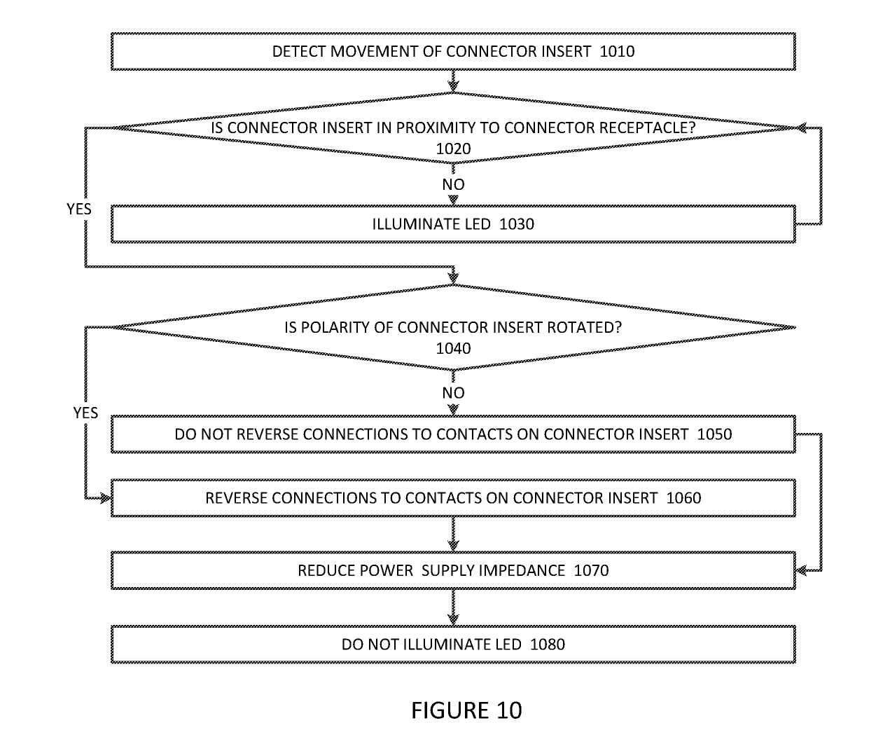

FIG. 10 is a flowchart of a method of operation of a connector insert according to an embodiment of the present invention. In act 1010, a movement of the connector insert may be detected. In act 1020, it may be determined whether the connector insert is in proximity to a corresponding connector receptacle. If it is not, an LED may be illuminated in act 1030. If the connector insert is in proximity to the connector receptacle, it may be determined in act 1040 whether the polarity of the connector insert is rotated. If the polarity of the connector insert is not rotated, then the connections to the contacts are not reversed in act 1050. If the connector insert is rotated, then the connections to the contacts may be reversed in act 1050. Once a proximity detection has been made, a power supply source impedance may be reduced in act 1070 and the LED may be shut off in act 1080. If the LED is illuminated in act 1030, once it is determined that the connector insert is proximate to the connector receptacle, it may be determined whether the polarity of the connector insert is rotated in act 1040, as before.

In various embodiments of the present invention, the components of the connectors may be formed in various ways of various materials. For example, contacts or pins, interconnect lines, and other conductive portions of the connectors may be formed by stamping, metal-injection molding, machining, printing, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions, such as the housings, and other portions, may be formed using injection or other molding, 3-D printing, machining, or other manufacturing process. The nonconductive portions may be formed of silicon or silicone, rubber, hard rubber, plastic, nylon, elastomers, liquid-crystal polymers (LCPs), ceramics, or other nonconductive material or combination of materials.

Embodiments of the present invention may provide connector inserts that may connect to connector receptacles on various types of devices, such as portable computing devices, tablet computers, desktop computers, laptops, all-in-one computers, wearable computing devices, cell phones, smart phones, media phones, storage devices, portable media players, navigation systems, monitors, power supplies, adapters, remote control devices, chargers, and other devices. These connector inserts and connector receptacles may be compliant with various standards such as Universal Serial Bus (USB), USB2, USB3, USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these connector inserts and connector receptacles may be used to convey power, ground, signals, test points, and other voltage, current, data, or other information. In a specific embodiment of the present invention, the connectors may include three contacts, a bidirectional power contact, a bidirectional data contact, and ground.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A connector insert comprising:
a plurality of contacts;
a sensing device to sense a first event; and
an output device coupled to the sensing device, the output device to provide a first output, the output device further coupled to receive a detect signal,
wherein when the sensing device detects the first event, the output device provides the first output, and
wherein when the output device receives the detect signal, the output device does not provide the first output.

2. The connector insert of claim 1 wherein the sensing device is accelerometer and the first event is movement of the connector insert.

3. The connector insert of claim 1 wherein the sensing device is touch sensor and the first event is a touch of a surface of the connector insert.

4. The connector insert of claim 2 wherein the output device is a light-emitting diode and the first output is light.

5. The connector insert of claim 2 wherein the output device is a haptic engine and the first output is tactile feedback as a user plugs the connector insert into a corresponding connector receptacle.

6. The connector insert of claim 2 wherein the output device is a speaker and the first output is an audio feedback as a user plugs the connector insert into a corresponding connector receptacle.

7. The connector insert of claim 4 wherein the detect signal indicates a connection to a corresponding connector receptacle.

8. The connector insert of claim 4 wherein the detect signal indicates the proximity of a corresponding connector receptacle.

9. The connector insert of claim 4 further comprising a reed switch, wherein the reed switch provides the detect signal to the output device.

10. A connector insert comprising:
a plurality of contacts;
a reed switch capable of being in a first state or a second state;
wherein when the reed switch is in the first state, the connector insert provides a power supply voltage having a first impedance, and
wherein when the reed switch is in the second state, the connector insert provides a power supply voltage having a second impedance, the second impedance lower than the first impedance.

11. A connector insert of claim 10 further comprising:
a sensing device to sense a first event; and
an output device coupled to the sensing device, the output device to provide a first output, the output device further coupled to the reed switch,
wherein when the sensing device detects the first event and the reed switch is in the first state, the output device provides the first output, and
wherein when the reed switch is in the second state, the output device does not provide the first output.

12. The connector insert of claim 11 wherein the sensing device is accelerometer and the first event is movement of the connector insert.

13. The connector insert of claim 12 wherein the output device is a light-emitting diode and the first output is light.

14. A connector insert comprising:
a plurality of contacts;
a Hall-effect sensor configured provide an output voltage, where the output voltage increases with increasing strength of a magnetic field and the output voltage provides an indication of the direction of the magnet field.

15. The connector insert of claim 14 wherein when the Hall-effect sensor provides an output voltage below a first threshold, the connector insert provides a power supply voltage having a first impedance, and
wherein when the Hall-effect sensor provides an output voltage above the first threshold, the connector insert provides a power supply voltage having a second impedance, the second impedance lower than the first impedance.

16. The connector insert of claim 15 further comprising a plurality of magnetic pole pieces to receive the magnetic field, change the direction of the magnetic field, and apply the changed magnetic field to the Hall-effect sensor.

17. The connector insert of claim 15 further comprising an input/output circuit coupled to a plurality of multiplexers, the plurality of multiplexers coupled to the plurality of contacts, wherein the output voltage may have a first sign or a second sign, and when the output voltage has the first sign, the multiplexers do not reverse the connections from the input/output circuit to the contacts, and when the output voltage has the second sign, multiplexers reverse the connections from the input/output circuit to the contacts.

18. The connector insert of claim 15 further comprising:
a sensing device to sense a first event; and
an output device coupled to the sensing device, the output device to provide a first output, the output device further coupled to the Hall-effect sensor,
wherein when the sensing device detects the first event and the Hall-effect sensor provides a voltage less than the threshold voltage, the output device provides the first output, and
wherein when the Hall-effect sensor provides a voltage greater than the threshold voltage, the output device does not provide the first output.

19. The connector insert of claim 18 wherein the sensing device is accelerometer and the first event is movement of the connector insert.

20. The connector insert of claim 19 wherein the output device is a light-emitting diode and the first output is light.
